(19) United States
(12) Patent Application Publication
(10) Pub. No.: US 2022/0108071 A1
(43) Pub. Date: Apr. 7, 2022

(54) INFORMATION PROCESSING DEVICE, INFORMATION PROCESSING SYSTEM, AND NON-TRANSITORY COMPUTER READABLE MEDIUM

(71) Applicant: FUJIFILM Business Innovation Corp., Tokyo (JP)

(72) Inventors: Eiichi TANAKA, Kanagawa (JP); Tadafumi KAWAGUCHI, Kanagawa (JP)

(73) Assignee: FUJIFILM Business Innovation Corp., Tokyo (JP)

(21) Appl. No.: 17/336,446

(22) Filed: Jun. 2, 2021

(30) Foreign Application Priority Data
Oct. 2, 2020 (JP) 2020-167489

(51) Int. Cl. G06F 40/284; G06F 40/30; G06F 16/35; G06N 20/00; G06K 9/62

(52) U.S. Cl. CPC G06F 40/284; G06F 40/30; G06K 9/6215; G06N 20/00; G06F 16/353

(57) ABSTRACT

An information processing device includes: a processor configured to: select pairs of tokens; when the selected pairs of tokens are presented to a user, receive an evaluation, made by the user, of degrees of relevance between the presented pairs of tokens; calculate degrees of relevance between the presented pairs of tokens based on the received evaluation; re-select pairs of tokens having comparative calculated degrees of relevance; when the re-selected pairs of tokens are presented to the user, re-receive an evaluation, made by the user, of degrees of relevance between the presented pairs of tokens; and re-calculate degrees of relevance between the presented pair of tokens based on the re-received evaluation.

### CROSS-REFERENCE TO RELATED APPLICATIONS

This application is based on and claims priority under 35 USC 119 from Japanese Patent Application No. 2020-167489 filed Oct. 2, 2020.

### BACKGROUND

### (i) Technical Field

The present disclosure relates to an information processing device, an information processing system, and a non-transitory computer readable medium.

### (ii) Related Art

In the related art, in order to collect a degree of relevance between a pair of tokens, an information processing device presents the pair of tokens to a user, acquires a degree of relevance determined by the user, and calculates the degree of relevance between the pair of tokens based on the acquired degree of relevance.

JP-A-2002-373237 discloses a method for deriving a meaningful unified response sequence. Even when the total number of evaluation target items prepared for a questionnaire purpose is fairly large, individual questionnaire answerers can answer a questionnaire without a heavy burden, and multi-dimensional answers from a large number of answerers are statistically processed to derive the meaningful unified response sequence that accurately reflects psychological evaluations of the questionnaire answerers for the large number of evaluation target items. In the answer analysis process of the method, n weighted presentation item sets accumulated in an answer database are aggregated, an n-dimensional multi-dimensional sequence by weighting of i evaluation target items in each set is unified based on a connection relationship between n presentation item sets, and a unified answer sequence is given to m evaluation target items.

### SUMMARY

However, in order to improve accuracy of a degree of relevance between a pair of tokens, a user needs to determine degrees of relevance between a large number of pairs of tokens, which imposes a large burden on the user. That is, when a large number of pairs of tokens are presented to ask the user for the determination, the number of pairs is large. In order to accurately check degrees of relevance between the pairs, the user needs to determine the degrees of relevance between a large number of pairs. Therefore, when a pair of tokens is presented, it is required to present a more efficient pair of tokens to calculate the degree of relevance instead of randomly presenting a pair of tokens to calculate the degree of relevance.

Aspects of non-limiting embodiments of the present disclosure relate to an information processing device, an information processing system, and a non-transitory computer readable medium capable of selecting a more efficient pair to calculate a degree of relevance as compared with a case where a pair of token is randomly selected when the pair of tokens is presented to a user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device includes: a processor configured to: select pairs of tokens; when the selected pairs of tokens are presented to a user, receive an evaluation, made by the user, of degrees of relevance between the presented pairs of tokens; calculate degrees of relevance between the presented pairs of tokens based on the received evaluation; re-select pairs of tokens having comparative calculated degrees of relevance; when the re-selected pairs of tokens are presented to the user, re-receive an evaluation, made by the user, of degrees of relevance between the presented pairs of tokens; and re-calculate degrees of relevance between the presented pair of tokens based on the re-received evaluation.

### BRIEF DESCRIPTION OF THE DRAWINGS

Exemplary embodiment(s) of the present disclosure will be described in detail based on the following figures, wherein:

FIG. 1 shows a configuration example of an information processing system according to an exemplary embodiment;

FIG. 2 shows an outline of an operation of the information processing system;

FIG. 3 is a block diagram showing a functional configuration example of the information processing system according to a first exemplary embodiment;

FIG. 4 is a flowchart of an operation of the information processing system according to the first exemplary embodiment;

FIG. 5 shows a case in which plural pairs of tokens are displayed and a user inputs evaluations of degrees of relevance between the displayed pairs;

FIGS. 6A to 6D show a method for grouping pairs of tokens and a method for presenting the grouped pairs of tokens;

FIG. 7 shows a method for inputting an evaluation of a degree of relevance by a user according to a first modification;

FIG. 8 is a block diagram showing a functional configuration example of an information processing system according to a second exemplary embodiment;

FIG. 9 is a flowchart of a method for automatically generating a pair of tokens; and

FIG. 10 is a schematic diagram showing a state in which plural tokens are clustered to create a cluster.

### DETAILED DESCRIPTION

Hereinafter, exemplary embodiments of the present disclosure will be described in detail with reference to the accompanying drawings.

### Overall Description of Information Processing System 1

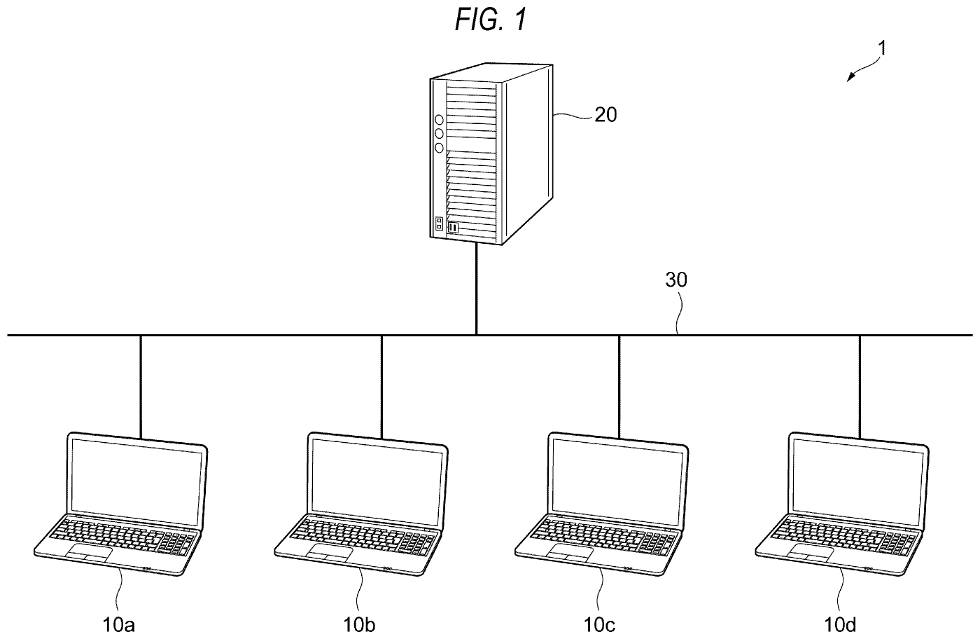

FIG. 1 shows a configuration example of the information processing system 1 according to an exemplary embodiment.

The shown information processing system 1 includes terminal devices 10a to 10d as terminal devices 10, and a management server 20. The terminal devices 10a to 10d and the management server 20 are connected to each other via a network 30.

The four terminal devices 10 are shown in FIG. 1. The number of the terminal devices 10 may be any number equal to or larger than one.

In FIG. 1, the information processing system 1 is an apparatus that acquires a degree of relevance between a pair of tokens. The term “pair of tokens” refers to a combination of the same type of data, and is, for example, a combination of texts. In this case, the text is, for example, a word, a compound word, or a sentence. The “pair of tokens” may also be a combination of images or sounds. The pair of tokens is usually a combination of two tokens. The pair of tokens may be a combination of three or more tokens. The “degree of relevance between a pair of tokens” refers to a degree of relevance between tokens constituting the pair of tokens. The degree of relevance between the pair of tokens may be represented by, for example, a numerical value of 0 or more and 10 or less. In this case, the degree of relevance between the pair of tokens increases as the numerical value increases.

The terminal device 10 is an example of a presentation device that presents the pair of tokens selected by the management server 20 to a user. The terminal device 10 presents a pair of tokens to a user in accordance with an operation by the user or an instruction from the management server 20. In this case, the terminal device 10 displays the pair of tokens to the user. Then, the terminal device 10 receives an evaluation of the degree of relevance between the pair of tokens from the user. The terminal device 10 is, for example, a computer device such as a general-purpose personal computer (PC), a mobile computer, a mobile phone, a smartphone, or a tablet computer. The terminal device 10 executes various application software under control of an operating system (OS), thereby displaying the pair of tokens and receiving the evaluation.

The management server 20 is an example of an information processing device that calculates the degree of relevance between the pair of tokens. The management server 20 is a server computer that manages the entire information processing system 1. For example, the management server 20 authenticates the user who operates the terminal device 10, and presents the pair of tokens to the user. Then, the management server 20 acquires information on the degree of relevance between the pair of tokens input to the terminal device 10 by the user and calculates the degree of relevance between the pair of tokens.

Each of the terminal device 10 and the management server 20 includes a central processing unit (CPU) serving as a calculator, a main memory serving as a storage unit, and a storage such as a hard disk drive (HDD) or a solid state drive (SSD). Here, the CPU is an example of a processor. The CPU executes various software such as an OS (basic software) and application software. The main memory is a storage region for storing various software and data used for executing the software. The storage is a storage region for storing input data for various software, output data from various software, and the like.

Furthermore, each of the terminal device 10 and the management server 20 includes a communication interface (hereinafter, referred to as a “communication I/F”) for communication with the outside, a display device including a video memory, a display, and the like, and an input device such as a keyboard, a mouse, and a touch panel.

The network 30 is a communication unit used for information communication between the terminal device 10 and the management server 20. For example, the network 30 is the Internet, a local area network (LAN), or a wide area network (WAN). A communication line used for data communication may be wired or wireless, or a combination thereof. The terminal device 10 and the management server 20 may be connected to each other via plural networks or communication lines using a relay device such as a gateway device or a router.

### Outline Description of Operation of Information Processing System 1

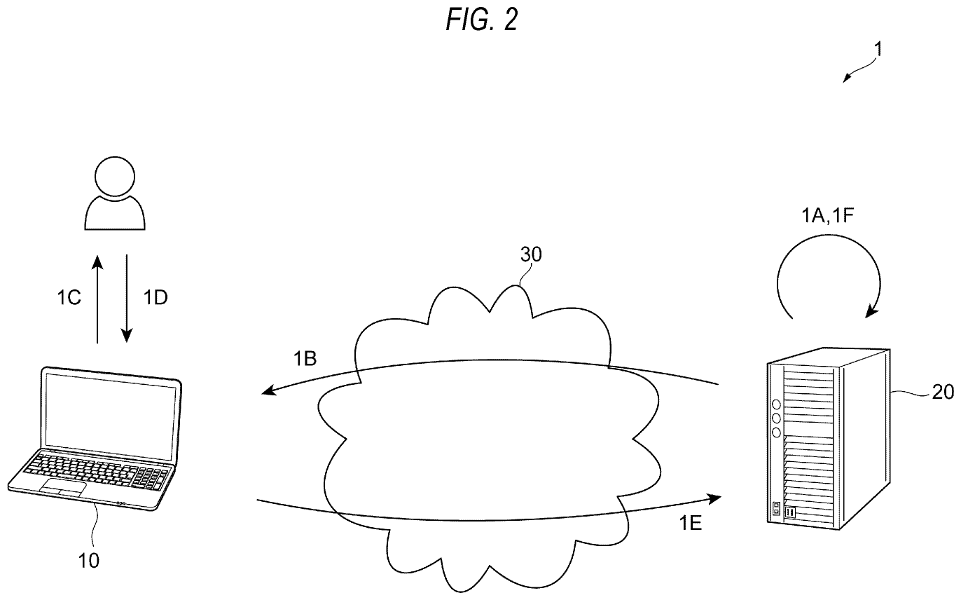

FIG. 2 shows an outline of an operation of the information processing system 1.

First, the management server 20 selects pairs of tokens (1A). In the present exemplary embodiment, there are plural pairs of tokens. Then, the management server 20 transmits data of the pairs of tokens to the terminal device 10 (1B).

The terminal device 10 displays the transmitted plural pairs of tokens and presents the pairs of tokens to the user (1C). In response, the user evaluates a degree of relevance between each of the presented pairs of tokens, and inputs an evaluation (1D). An evaluation result is transmitted to the management server 20 (1E).

The management server 20 calculates the degrees of relevance between the presented pairs of tokens based on the transmitted evaluation of the degrees of relevance (1F).

Thereafter, the operations 1A to 1F are repeated. That is, the management server 20 re-selects pairs of tokens (1A). Next, data of the re-selected pairs of tokens is retransmitted to the terminal device 10 (1B). Then, the terminal device 10 re-presents the transmitted plural pairs of tokens to the user (1C). The user re-evaluates the degree of relevance between each of the re-presented pairs of tokens, and inputs an evaluation result (1D). Then, the evaluation result is transmitted to the management server 20 (1E). The management server 20 re-calculates the degrees of relevance between the re-presented pairs of tokens based on the transmitted evaluation of the degrees of relevance (1F).

### Detailed Description of Information Processing System 1

### First Exemplary Embodiment

Next, the information processing system 1 will be described in detail.

First, the information processing system 1 according to a first exemplary embodiment will be described. In the first exemplary embodiment, the information processing system 1 classifies pairs of tokens into groups based on degrees of relevance, and collectively presents plural pairs of tokens included in a group to the user. Then, the information processing system 1 receives evaluation, made by the user, of the degrees of relevance between the pairs of tokens. When the pairs of tokens are to be re-presented, pairs of tokens having comparable calculated degrees of relevance are re-selected and re-presented. Here, the “pairs of tokens having the comparable calculated degree of relevance” refers to pairs of tokens in which a difference between calculated degrees of relevance falls within a predetermined range.

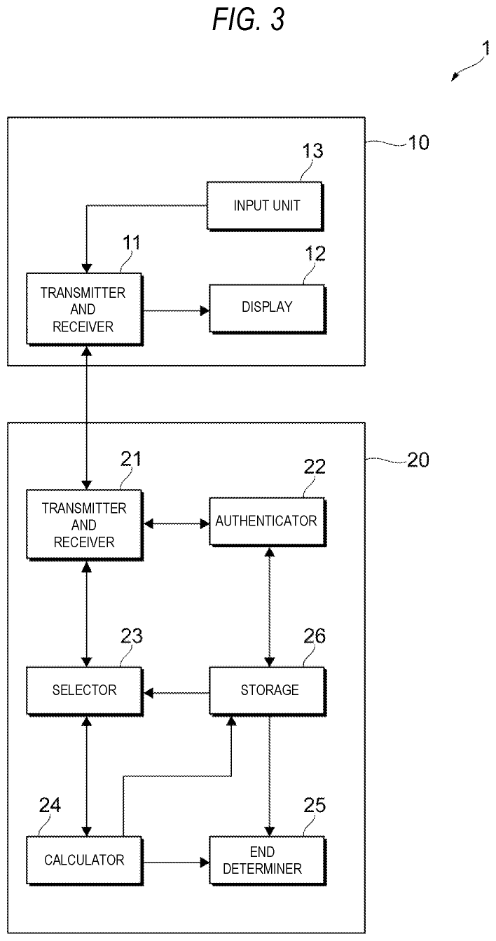

FIG. 3 is a block diagram showing a functional configuration example of the information processing system 1 according to the first exemplary embodiment.

Here, functions related to the present exemplary embodiment are selected from among various functions of the information processing system 1 and shown in FIG. 3.

The terminal device 10 shown in FIG. 3 includes a transmitter and receiver 11, a display 12, and an input unit 13. The transmitter and receiver 11 transmits data to and receives data from the management server 20. The display 12 displays pairs of tokens. The input unit 13 allows the user to input the evaluation.

The transmitter and receiver 11 receives the pairs of tokens transmitted from the management server 20 via the network 30. The transmitter and receiver 11 corresponds to, for example, a communication I/F.

The display 12 presents the pairs of tokens to the user by displaying the pairs of tokens selected by the management server 20 in accordance with the operation of the user. The display 12 corresponds to, for example, a display device.

The input unit 13 receives an evaluation result when the user who views the pairs of tokens evaluates the degrees of relevance. The input unit 13 corresponds to, for example, an input device.

The management server 20 includes a transmitter and receiver 21, an authenticator 22, a selector 23, a calculator 24, an end determiner 25, and a storage 26. The transmitter and receiver 21 transmits data to and receives data from the terminal device 10. The authenticator 22 authenticates the user. The selector 23 selects the pairs of tokens. The calculator 24 calculates the degrees of relevance between the pairs of tokens. The end determiner 25 determines an end of a process. The storage 26 stores information on the tokens.

The transmitter and receiver 21 transmits the selected pairs of tokens to the terminal device 10. When the selected pairs of tokens are presented to the user by the terminal device 10, the transmitter and receiver 21 receives the evaluation, made by the user, of the degrees of relevance between the presented pairs of tokens. The transmitter and receiver 21 corresponds to, for example, the communication I/F.

The authenticator 22 authenticates the user by a predetermined method. For example, the authenticator 22 compares a user ID and a password transmitted from the user with a user ID and a password stored in the storage 26. As a result, if both the user ID and the password match, the user is authenticated.

The selector 23 calculates the pairs of tokens. Here, each of the tokens is a word. A large number of words are stored in the storage 26. Then, the selector 23 selects pairs to be evaluated by the user from among these words.

The calculator 24 calculates the degrees of relevance between the presented pairs of tokens based on the evaluation received by the transmitter and receiver 21.

The end determiner 25 presents the pairs of tokens to the user and determines whether to end the repeated process of acquiring the evaluation. The end determiner 25 ends the process when the degrees of relevance between the pairs of tokens calculated by the calculator 24 hardly change. That is, when the calculated degrees of relevance between the pairs of tokens converge, the series of processes is ended. Alternatively, the process may end when the number of times of repetition reaches a predetermined number of times.

The storage 26 stores information on the pairs of tokens and the degrees of relevance between the pairs of tokens. The storage 26 stores the evaluation made by the user.

Next, an example of the operation of the information processing system 1 according to the present exemplary embodiment will be described in more detail.

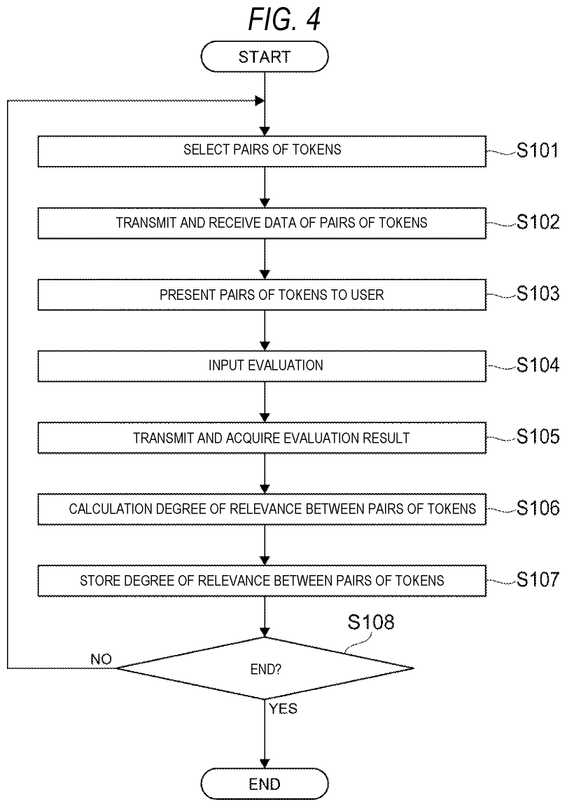

FIG. 4 is a flowchart of an operation of the information processing system 1 according to the first exemplary embodiment.

First, the selector 23 of the management server 20 selects pairs of tokens (step 101). In the present exemplary embodiment, plural pairs of tokens are selected by the selector 23.

Then, the transmitter and receiver 21 transmits data of the pairs of tokens to the terminal device 10. In the terminal device 10, the transmitter and receiver 11 receives the data of the pairs of tokens (step 102).

Furthermore, the display 12 displays the pairs of tokens to present the pairs of tokens to the user (step 103). In response, the user evaluates the degree of relevance between each of the presented pairs of tokens, and inputs the evaluation (step 104). The evaluation is received by the input unit 13.

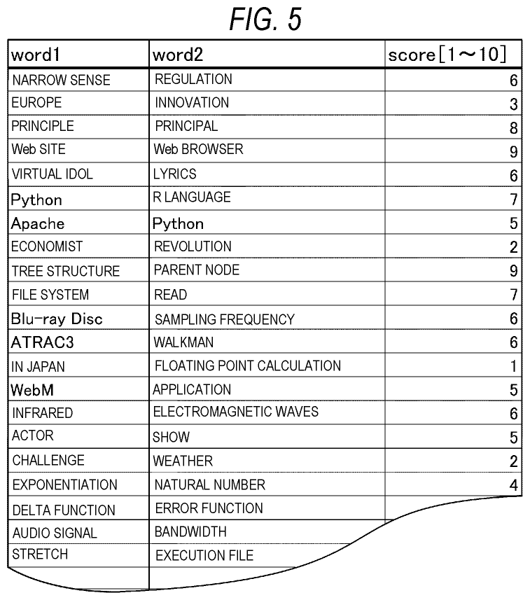

FIG. 5 shows a case in which plural pairs of tokens are displayed and the user inputs the evaluation of the degrees of relevance between the displayed pairs of tokens.

Here, as shown in FIG. 5, pairs of a word1 and a word2 are displayed as the plural pairs of tokens. FIG. 5 shows a case in which a numerical value of 1 to 10 is input to a “score (1 to 10)” column as the evaluation made by the user. In this case, the score means that the larger the numerical value is, the larger the degree of relevance is evaluated to be, and the smaller the numerical value is, the smaller the relevance is evaluated to be.

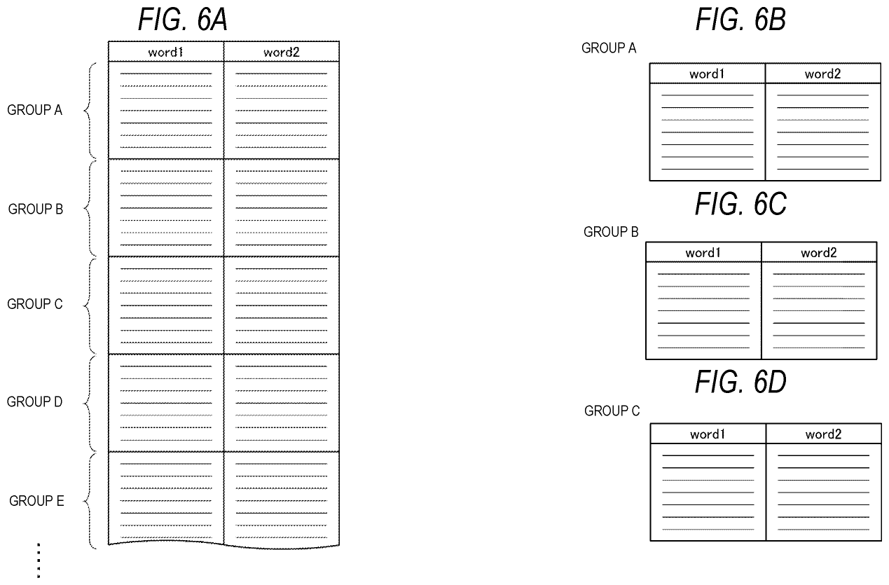

In the present exemplary embodiment, the pairs of tokens are classified into groups based on the degrees of relevance. As shown in FIG. 6, the plural pairs of tokens included in the group are collectively presented to the user. In this case, the plural pairs of tokens having the comparable degree of relevance are simultaneously presented to the user. The number of presented pairs of tokens may be the number of pairs that the user can check simultaneously.

Here, the user inputs one of consecutive values 1 to 10. Alternatively, the user may input discrete values instead of the consecutive values. The user may input a value using a slider.

Returning to FIG. 4, the evaluation result is transmitted to the management server 20 via the transmitter and receiver 11, and the transmitter and receiver 21 acquires the evaluation result (step 105).

Next, the calculator 24 calculates the degrees of relevance between the presented pairs of tokens based on the evaluation of the user (step 106).

Then, the calculator 24 stores the calculated degrees of relevance between the pairs of tokens in the storage 26 (step 107).

Next, the end determiner 25 determines whether to end the series of processes (step 108). As described above, when the calculated degrees of relevance between the pairs of tokens converge, the end determiner 25 ends the series of processes. In other words, the series of processes is repeated until the calculated degrees of relevance between the pairs of tokens converge. Specifically, the end determiner 25 calculates a difference between the degree of relevance between the pair of tokens calculated by the calculator 24 and the degree of relevance between the pair of tokens stored in the storage 26. That is, the end determiner 25 calculates a difference between the degree of relevance between the pair of tokens calculated by the calculator 24 and the degree of relevance between the pairs of tokens previously calculated by the calculator 24. Then, the end determiner 25 counts the number of pairs each having the difference equal to or less than a predetermined specified value. At this time, if the number of pairs is equal to or greater than a specified value, it is considered that the degree of relevance converges. Thus, the end determiner 25 determines to end the process. Instead of the number of pairs, a ratio of pairs each having the difference equal to or less than a predetermined specified value may be used.

On the other hand, if the number of pairs is less than the specified value, the end determiner 25 determines not to end the process.

Then, when the end determiner 25 determines to end the process (Yes in step 108), the process ends.

On the other hand, when the end determiner 25 determines not to end the process (No in step 108), the process returns to step 101. Then, the processes of steps 101 to 108 are performed again. That is, pairs of tokens having the comparable calculated degrees of relevance are re-selected (step 101). Further, the re-selected pairs of tokens are presented to the user again (step 103). In response, the user evaluates the degree of relevance between each of the presented pairs of tokens, and inputs the evaluation (step 104). Accordingly, the degrees of relevance between the re-presented pairs of tokens input by the user is received again. Further, the degrees of relevance between the presented pairs of tokens are re-calculated based on the re-received evaluation (step 106).

At this time, when re-selection is performed in step 101, pairs of tokens having comparable degrees of relevance are set as the same group. This can also be said that the pairs of tokens having the comparable calculated degrees of relevance are selected to be in the same group.

In step 103, a group including pairs of tokens having a high degree of relevance may be preferentially presented.

FIGS. 6A to 6D show a method for grouping the pairs of tokens and a method for presenting the grouped pairs of tokens.

Here, in order to group the pairs of tokens, for example, the pairs of tokens are arranged in order of the degrees of relevance, and are classified into n pairs for presentation where n is a predetermined number.

FIG. 6A shows a case where the pairs of tokens are arranged in the order of the degrees of relevance. Here, the higher the position in FIG. 6A, the higher the degree of relevance calculated by the calculator 24. The lower the position in FIG. 6A, the lower the degree of relevance calculated by the calculator 24.

Then, the number of pairs of tokens to be presented is set to, for example, 10. The pairs of tokens are divided in ten pairs and classified into groups. FIG. 6A shows an example in which the pairs of tokens are classified into a group A, a group B, a group C, a group D, a group E.

Further, when the grouped pairs of tokens are presented, a group including pairs of tokens having a high degree of relevance is preferentially presented. In this case, the pairs of tokens are displayed in order of FIGS. 6B to 6D. That is, the group A, the group B, and the group C are displayed in this order. All groups into which the pairs of tokens are grouped do not have to be displayed in this manner. Only groups having a degree of relevance equal to or higher than the specified value may be displayed. In this case, for example, the group D and the subsequent groups are not displayed. The pairs of tokens having a low calculated degree of relevance have a low degree of importance. A group to which such pairs of tokens belong is not displayed or evaluated by the user.

In order to prevent a layout of the displayed pairs of tokens from influencing the user's evaluation, the layout may be randomized. Accordingly, even if the same pairs of token are displayed again, the pairs are displayed at different positions, and the influence of the layout can be reduced.

There may be plural evaluations even for the same pair of tokens, for example, in a case where the user evaluates the same pair of tokens plural times or in a case where plural users evaluate the same pair of tokens. In this case, an average of the evaluations may be used. Alternatively, a weighted average may be used such that a weight given to an answer increases as the answer is made later.

In general, a method for acquiring the degrees of relevance between pairs of tokens by presenting the pairs of tokens to the user and acquiring the evaluation made by the user has the following problems.

It is not always easy for the user to evaluate a degree of relevance numerically for a certain pair of tokens. That is, there is generally no objective measurement method for a degree of relevance. A criterion value does not necessarily exist. Therefore, it may be difficult for the user to evaluate a degree of relevance between a pair of tokens. As a result, it is a difficult work for the user to answer the degree of relevance between each pair of tokens numerically. There is a problem from a viewpoint of collection efficiency when the evaluation is acquired.

For the same reason, fluctuation occurs in the evaluation made by the user. Thus, there is also a problem in the accuracy of the evaluation. That is, depending on the user, the answer to the same pair of tokens may be different. Even for the same user, the answer to the same pair of tokens may be different depending on a situation. In particular, for a pair of tokens having a high degree of relevance therebetween, it is desired to acquire an evaluation with higher accuracy. However, it is difficult to acquire the evaluation with the method in the related art.

Since the user makes the relative evaluation on limited plural pairs of tokens, an answer criterion may change between plural different pairs. This causes deterioration in the accuracy of the obtained degree of relevance. Therefore, in the present exemplary embodiment, the degree of relevance is re-calculated based on the obtained evaluation. Based on the calculated degree of relevance, pairs having the comparable degrees of relevance are collected and presented to the user again as a group. Accordingly, the difference in the degree of relevance between the plural pairs of tokens is corrected. Further, the user re-evaluates the degrees of relevance between the pairs of tokens having the comparable calculated degree of relevance.

Furthermore, by repeating the above process, the user is required to determine a subtle difference in the degree of relevance in a later stage than in the initial stage of the work. This is a mechanism in which a difficulty level of the evaluation increases according to user's proficiency of the evaluation work.

As a method for acquiring a degree of relevance between a pairs of tokens, there is a method for using rules such as grammar. However, this method has a limited application range since this method cannot deal with a text of informal expression.

As another method, there is a method using distributed expression. Since this method is an automatic method having a wide application range, it is easy to cover a relationship between a large number of pairs of tokens. On the other hand, the accuracy of obtained degrees of relevance tends to be lower than the above described method in which the user makes evaluation.

### First Modification

Next, a first modification will be described as a modification of the first exemplary embodiment.

In the first modification, an evaluation of degrees of relevance by a user is an order of pairs of tokens after the pairs of tokens presented collectively are rearranged according to the degrees of relevance.

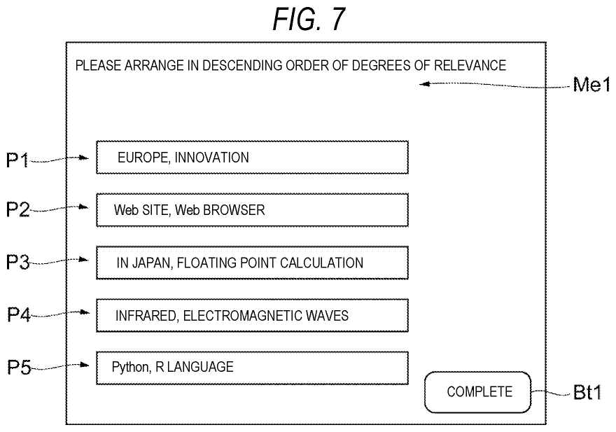

FIG. 7 shows a method for inputting an evaluation of degrees of relevance by the user according to the first modification.

Here, as shown in FIG. 7, P1 to P5 are displayed as plural pairs of tokens. Then, a message Mel of “Please arrange pairs in descending order of degrees of relevance” is displayed. The user rearranges the pairs of tokens P1 to P5 in descending order of the degrees of relevance. The user may rearrange the pairs of tokens, for example, by performing an operation such as dragging and dropping using an input device such as a mouse.

Then, the pairs of tokens P1 to P5 are rearranged in descending order of the degrees of relevance, and then a completion button Bt1 is pressed, so that the evaluation is determined.

In the first modification, the calculator 24 first acquires a magnitude relationship between the degrees of relevance between the pairs of tokens, based on the order of the pairs of tokens evaluated by the user. Then, the calculator 24 calculates the degrees of relevance between the pairs of tokens based on the magnitude relationship between the degrees of relevance.

As a result of the rearrangement, only the magnitude relationship between consecutive pairs of tokens may be used, or all the magnitude relationships that can be obtained from the order may be used. A method in the middle may be used. All magnitude relationships that can be obtained from the order of partially consecutive pairs of tokens may be used. For example, when the pairs of tokens P1 to P5 are in the order of P1>P2>P3>P4>P5, the magnitude relationships of P1>P2, P2>P3, P3>P4, P4>P5, P1>P3, P2>P4, and P3>P5 are obtained from the arrangement order of two consecutive pairs.

The degrees of relevance can be calculated based on the magnitude relationship between the degrees of relevance by calculating winning percentages of the pairs of tokens based on the magnitude relationship by an existing method. Alternatively, strengths (βᵢ) of the pairs calculated from the magnitude relationship between the degrees of relevance based on a Brady-Terry Model shown in the following formula 1 can be used as the degrees of relevance.

$$P ( i > j ) = \frac{{e}^{{β}_{i}}}{{e}^{{β}_{i}} + {e}^{{β}_{j}}}$$

In the first modification, as shown in FIG. 5, the user does not answer the degree of relevance by a numerical value, but evaluates only a comparison result.

### Second Exemplary Embodiment

Next, an information processing system 1 according to a second exemplary embodiment will be described. In the second exemplary embodiment, when pairs of tokens are prepared in advance, the pairs of tokens are automatically generated.

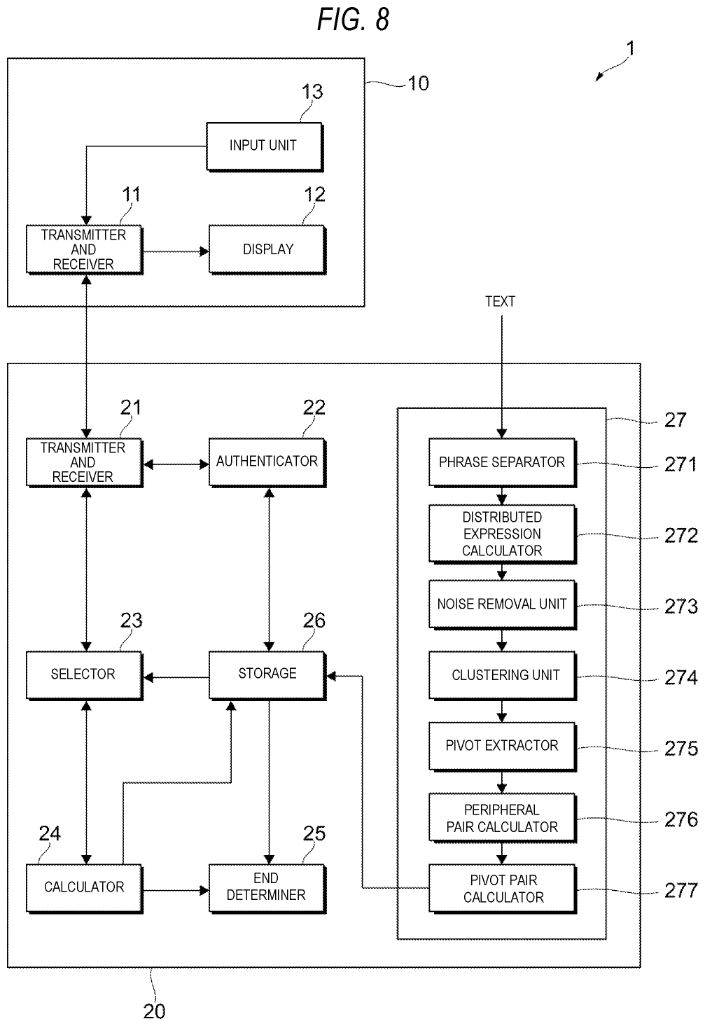

FIG. 8 is a block diagram showing a functional configuration example of the information processing system 1 according to the second exemplary embodiment.

The shown functional configuration example of the information processing system 1 is different from that in the first exemplary embodiment shown in FIG. 3 in that a pair generator 27 is added to the management server 20. The other configurations are the same.

The pair generator 27 has a function of automatically generating pairs of tokens. The pair generator 27 includes a phrase separator 271, a distributed expression calculator 272, a noise removal unit 273, a clustering unit 274, a pivot extractor 275, a peripheral pair calculator 276, and a pivot pair calculator 277.

In the first exemplary embodiment, the pairs of tokens need to be prepared in advance and stored in the storage 26 in advance. However, preparing the pairs of tokens in advance by an administrator or the like of the management server 20 requires a large amount of time and load.

Moreover, in general, there are a large number of types of tokens used in a system. For example, when tokens are words, hundreds of thousands of tokens including compound words are often used. The number of pairs of tokens for which degrees of relevance are calculated is a square of the number of tokens. In this way, it is inefficient to request a user to evaluate all pairs of a large number of tokens. That is, in general, degrees of relevance between pairs of tokens selected at random are often small. It is inefficient to request the user to evaluate such pairs of tokens. Therefore, in order to collect the evaluation more efficiently, it is desirable to collect pairs of tokens that are expected to have high degrees of relevance in advance.

Therefore, in the second exemplary embodiment, pairs of tokens to be selected are created in advance based on an input text and based on a distributed expression as described below. Accordingly, the pairs of tokens expected to have high degrees of relevance are automatically generated. The “distributed expression” is also referred to as word embedding, and is a technique of expressing a token such as a word by a high dimensional real vector. When a token is a word, in distributed expression, words having similar meanings can be expected to be similar vectors.

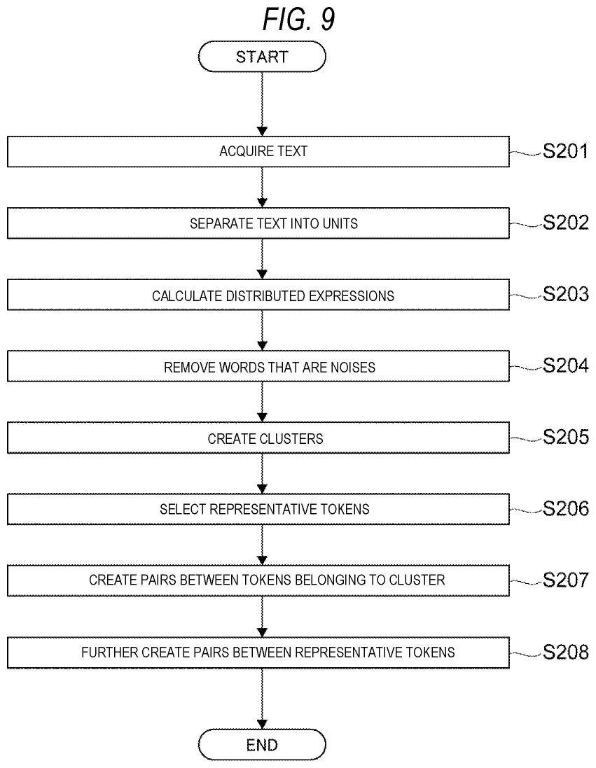

FIG. 9 is a flowchart of a method for automatically generating the pairs of tokens.

First, the transmitter and receiver 21 acquires a text (step 201). The text is input by, for example, the administrator of the management server 20. The text is not particularly limited as long as the text includes sentences in a language for which degrees of relevance between pairs of tokens are desired to be acquired. Examples of the sentences include books and newspaper articles.

Next, the phrase separator 271 of the pair generator 27 separates the acquired text into units that are candidates for pairs of tokens (step 202). Here, a case where tokens are words will be described.

Further, the distributed expression calculator 272 calculates distributed expressions of the words into which the text is separated by the phrase separator 271 (step 203).

The noise removal unit 273 removes unnecessary words according to a predetermined rule. That is, the noise removal unit 273 removes words that are noise (step 204).

Next, the clustering unit 274 clusters plural tokens based on the distributed expressions to create clusters (step 205). Clustering can be performed using a distance in a distributed expression space, such as by a k-means method or a Gaussian Mixture Model. In this case, for example, a Euclidean distance in the distributed expression space may be used as the distance. Alternatively, cosine similarity in the distributed expression space may be used.

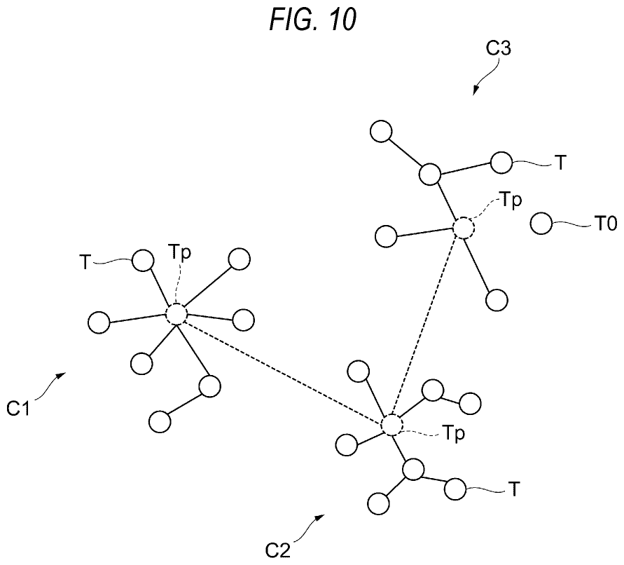

FIG. 10 is a schematic diagram showing a state in which plural tokens are clustered to create clusters.

Here, FIG. 10 shows a case in which tokens T represented by solid lines “∘” or dotted lines “∘” are clustered to create clusters C1 to C3 as clusters C.

Here, the cluster C1 includes eight tokens T. Similarly, the cluster C2 includes eight tokens T. The cluster C3 includes six tokens T. The token T represented by a token TO does not belong to any cluster C. There may be such a token T that is not clustered in this manner.

Returning to FIG. 9, next, the pivot extractor 275 selects a representative token Tp from among the tokens T belonging to each cluster C (step 206). The representative token Tp is used as a pivot. In FIG. 10, the representative token Tp is indicated by a dotted line “o”. The representative token Tp serving as a pivot may be a token T closest to a center in the distributed expression space among the tokens T included in a certain cluster C. The present disclosure is not limited thereto. For example, the representative token Tp serving as a pivot may be intentionally selected by the administrator or the like.

Further, the peripheral pair calculator 276 creates pairs between the tokens T belonging to each cluster C (step 207). Specifically, for each cluster C, pairs are created from the representative token Tp serving as the pivot to the peripheral tokens T. In FIG. 10, the tokens T to be paired are indicated by solid lines. In this case, for example, as shown in FIG. 10, the pairs are created between the representative token Tp and the peripheral tokens T. This can also be said that the pairs are created between the representative token Tp and the remaining tokens T belonging to each cluster C.

As shown in FIG. 10, the pairs may be created between the peripheral tokens T. In this case, each pair is created such that a token T and a coupling component represented by the solid line on the graph constitutes the pair. In order to create such pairs of tokens T, it is possible to perform, in a manner of recursively repeating, the pair selection of a certain token T and a token T in the vicinity of the certain token T in the distributed expression space. Accordingly, a tree structure coupling is obtained in each cluster C. Then, a graph in which all the tokens T in the cluster C have paths is obtained. As a result, the pairs of tokens T covering more tokens T can be generated.

Further, the pivot pair calculator 277 further creates pairs between the representative tokens Tp of the clusters C (step 208). The pairs of the representative tokens Tp can be created by calculating a minimum spanning tree only for the representative tokens Tp with respect to the distance in the distributed expression space. At this time, pairs designated by the administrator or the like may be inserted. Accordingly, a set of pairs that is a graph in which many words are covered and all the tokens T have paths is obtained.

In the second exemplary embodiment, the pairs of tokens T can be automatically generated and the pairs of tokens T can be prepared in advance. Then, the processing described with reference to FIG. 4 is performed using the prepared pairs of tokens. The pairs of tokens prepared here are selected based on the distributed expression, and are pairs of tokens expected to have a high degree of relevance.

### Second Modification

Next, a second modification will be described as a modification of the second exemplary embodiment.

In the second modification, the distributed expression is additionally learned based on the calculated degree of relevance of the pairs of tokens T, and the pairs of tokens T are re-selected based on the additionally learned distributed expression.

Specifically, the pair generator 27 additionally learns the distributed expression based on the degree of relevance of the pairs of tokens T calculated by the calculator 24. Then, the pair generator 27 generates pairs of tokens by the method shown in FIG. 10 based on the distributed expression after the additional learning. Then, the processing described with reference to FIG. 4 is performed using the generated pairs of tokens.

### Third Modification

Next, a third modification will be described as a modification of the second exemplary embodiment.

In the third modification, the information processing system 1 described above has a search function. In this case, for example, the information processing system 1 further receives a search instruction from the user at the terminal device 10, and displays a search result on the terminal device 10. At this time, the management server 20 determines the search result based on the calculated degree of relevance of the pairs of tokens with respect to a token such as a word input by the user. Specifically, the management server 20 refers to the degree of relevance of the pairs of tokens calculated by the method shown in FIG. 4. The degree of relevance is stored in the storage 26. Then, a token having a higher degree of relevance with the token input by the user is extracted. Further, a content related to both the token input by the user and the extracted token is displayed to the user as a search result. That is, an “and search” is performed between the token input by the user and the token having a higher degree of relevance with the token. At this time, the search result in the case where the degree of relevance between the input token and the extracted token is higher is displayed at a higher level.

Accordingly, for example, by inputting a token such as a word, the user performs the “and search” with a token related to the token.

### Description of Program

Here, processing performed by the management server 20 in the present exemplary embodiments described above is prepared as a program such as application software.

Therefore, the process performed by the management server 20 according to the present exemplary embodiments may be regarded as a program. The program causes a computer to implement a function of selecting pairs of tokens; when the selected pairs of tokens are presented to a user, receiving an evaluation, made by the user, of degrees of relevance between the presented pairs of tokens; calculating degrees of relevance between the presented pairs of tokens based on the received evaluation; re-selecting pairs of tokens having comparative calculated degrees of relevance; when the re-selected pairs of tokens are presented to the user, re-receiving an evaluation, made by the user, of degrees of relevance between the presented pairs of tokens; and re-calculating degrees of relevance between the presented pair of tokens based on the re-received evaluation.

The program that implements the present exemplary embodiments may be provided by a communication unit, or by being stored in a recording medium such as a CD-ROM.

Although the present exemplary embodiments are described above, the technical scope of the present disclosure is not limited to the above exemplary embodiments. It is apparent from the description of the scope of the claims that various modifications or improvements added to the exemplary embodiments described above are also included in the technical scope of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to:
select pairs of tokens;
when the selected pairs of tokens are presented to a user, receive an evaluation, made by the user, of degrees of relevance between the presented pairs of tokens;
calculate degrees of relevance between the presented pairs of tokens based on the received evaluation;
re-select pairs of tokens having comparative calculated degrees of relevance;
when the re-selected pairs of tokens are presented to the user, re-receive an evaluation, made by the user, of degrees of relevance between the presented pairs of tokens; and
re-calculate degrees of relevance between the presented pair of tokens based on the re-received evaluation.

2. The information processing device according to claim 1, wherein
the processor is configured to:
classify the pairs of tokens into groups based on the degrees of relevance; and
when pairs of tokens included in a group are collectively presented to the user, receive an evaluation, made by the user, of the degrees of relevance between the pairs of tokens included in the group.

3. The information processing device according to claim 2, wherein
the processor is configured to classify the pairs of tokens having comparative degrees of relevance into the same group.

4. The information processing device according to claim 3, wherein
the processor is configured to preferentially present a group including pairs of tokens having high degrees of relevance.

5. The information processing device according to claim 2, wherein
the evaluation, made by the user, of the degrees of relevance is an order of the pairs of tokens after the pairs of tokens presented collectively are rearranged according to the degrees of relevance.

6. The information processing device according to claim 1, wherein
the processor is configured to create the pairs of tokens to be selected in advance based on a distributed expression.

7. The information processing device according to claim 6, wherein
the processor is configured to:
cluster plural pairs of tokens based on the distributed expression to create clusters; and
create pairs among tokens belonging to each cluster.

8. The information processing device according to claim 7, wherein
the processor configured to:
select a representative token from among the tokens belonging to each cluster; and
create pairs between the representative token and the remaining tokens belonging to each cluster.

9. The information processing device according to claim 8, wherein
the processor is configured to further create a pair between the representative tokens.

10. The information processing device according to claim 6, wherein
the processor is configured to:
perform additional learning of the distributed expression based on the calculated degrees of relevance between the pairs of tokens; and
re-select pairs of tokens based on the additionally learned distributed expression.

11. The information processing device according to claim 1, wherein
the processor is configured to repeat the selection, the reception, and the calculation of the pairs of tokens based on the calculated degrees of relevance between the pairs of tokens until the calculated degrees of relevance between the pairs of tokens converge.

12. An information processing system comprising:
an information processing device configured to a degrees of relevance between pairs of tokens; and
a presentation device configured to present pairs of tokens selected by the information processing device to a user, wherein
the information processing device comprises
a processor configured to:
select the pairs of tokens;
when the selected pairs of tokens are presented to the user, receive an evaluation, made by the user, of degrees of relevance between the presented pairs of tokens;
calculate degrees of relevance between the presented pairs of tokens based on the received evaluation;
re-select pairs of tokens having comparative calculated degrees of relevance;
when the re-selected pairs of tokens are presented to the user, re-receive an evaluation, made by the user, of degrees of relevance between the presented pairs of tokens; and
re-calculate degrees of relevance between the presented pair of tokens based on the re-received evaluation.

13. The information processing system according to claim 12, wherein
the processor of the information processing device is further configured to:
receive a search instruction from the user; and
determine a search result based on the calculated degrees of relevance between the pairs of tokens.

14. A non-transitory computer readable medium storing a program that causes a computer to execute information processing, the information processing comprising:
selecting pairs of tokens;
when the selected pairs of tokens are presented to a user, receiving an evaluation, made by the user, of degrees of relevance between the presented pairs of tokens;
calculating degrees of relevance between the presented pairs of tokens based on the received evaluation;
re-selecting pairs of tokens having comparative calculated degrees of relevance;
when the re-selected pairs of tokens are presented to the user, re-receiving an evaluation, made by the user, of degrees of relevance between the presented pairs of tokens; and
re-calculating degrees of relevance between the presented pair of tokens based on the re-received evaluation.
